(19) United States
(12) Patent Application Publication
(10) Pub. No.: US 2002/0170664 A1
(43) Pub. Date: Nov. 21, 2002

(54) Method for manufacturing pipe having double layers

(76) Inventor: Jejin Ryu, Gyeongsangbuk-do (KR)

Correspondence Address: Sheridan Ross, Suite 1200, 1560 Broadway, Denver, CO, 80202-5141, US

(21) Appl. No.: 10/111,966

(22) PCT Filed: Sep. 25, 2001
(86) PCT No.: PCT/KR01/01601

(30) Foreign Application Priority Data
Oct. 26, 2000 (KR) 2000/63233

(51) Int. Cl. B32B 31/00

(52) U.S. Cl. 156/272.6; 156/294; 156/274.4

(57) ABSTRACT

Disclosed is a method for manufacturing a pipe having double layers, which enables the adhesion between a metal pipe layer and a synthetic resin pipe layer of the pipe to be stably maintained even when external environment changes. In the method, a synthetic resin pipe having a double layer-structure is formed, and the synthetic resin pipe is inserted into a metal pipe. Then, the metal pipe is heated to make an adhesive resin of the synthetic resin pipe be heated up to a softening temperature of the synthetic resin pipe, and air between an inner surface of the metal pipe and an outer surface of the synthetic resin pipe is exhausted, so as to make a space between the inner surface of the metal pipe and the outer surface of the synthetic resin pipe be vacuum. In result, the metal pipe and the synthetic resin pipe are bonded together.

### TECHNICAL FIELD

The present invention relates to a method for manufacturing a pipe, and more particularly to a method for manufacturing a pipe having double layers by bonding a metal pipe and a synthetic resin pipe together.

### BACKGROUND ART

As generally known in the art, methods for manufacturing a pipe having multiple layers, such as a pipe having double layers consisting of a metal pipe layer and a synthetic resin pipe layer, is classified into two types, including one, in which the layers are adhered to each other by means of a die, and the other, in which the pipe is manufactured by means of heat and air pressure.

In the former type of method, an inner die for molding a receiving port is disposed in a diameter-expanded end of a metallic pipe, one end of which is diametrically expanded conforming to a shape of the receiving port, and a synthetic resin pipe having an outer diameter smaller than an inner diameter of the metal pipe is pushed into the metal pipe from a lower end of the metal pipe. Then, a tip of the synthetic resin pipe is pushed into a space between the diameter-expanded end of the metal pipe and the inner die without clearance and then is molded. Thereafter, other portions of the metal pipe than the diameter-expanded end are diametrically contracted to make an inner surface of the metal pipe be in close contact with an outer surface of the synthetic resin pipe, so that a production of the pipe having double layers is completed.

In the latter type of method, inner and outer portions of the metal pipe are subjected to a shotting treatment and then are heated to a temperature of about 130° C., while the outer surface of the synthetic resin pipe is subjected to a scratching treatment and then an adhesive agent is applied onto the outer surface of the synthetic resin pipe. Thereafter, the synthetic resin pipe is inserted into the metal pipe and the metal pipe with the inserted synthetic resin pipe is secondarily heated, and then air present between the inner surface of the metal pipe and the outer surface of the synthetic resin pipe is discharged into the synthetic resin pipe by means of the air pressure. Then, a pipe having double layers is completely produced.

According to the above-mentioned methods for manufacturing a pipe having double layers, the synthetic resin pipe is tightly bonded to the metal pipe in a forced manner by physical forces. Even in the case where the metal pipe and the synthetic resin pipe are tightly bonded together at an initial time of being manufactured, a gap may be generated at an interface between the metal pipe layer and the synthetic resin pipe layer when the two layers are contracted in the winter season, due to the differences of a thermal expansion coefficient and a contractive deformation modulus between the two layers, thus deteriorating coherency between two pipes.

In order to solve this problem of coherency deterioration in the above-mentioned pipe having double layers, there has been proposed a method of manufacturing a pipe having double layers within a cooling chamber. In the method of manufacturing a pipe having double layers within a cooling chamber, the metal pipe and the synthetic resin pipe are cooled at the same temperature (−20° C.), while the outer diameter of the synthetic resin pipe is formed larger than the inner diameter of the metal pipe, since the contractive deformation modulus of the synthetic resin pipe is larger than that of the metal pipe (See Korean Patent Laid-open No. 1999-0084132).

In manufacturing the pipe having double layers according to this method, at first, an adhesive agent is applied on the outer surface of the synthetic resin pipe, and the synthetic resin pipe together with the metal pipe is cooled within the cooling chamber, to render the outer diameter of the synthetic resin pipe to be smaller than the inner diameter of the metal pipe by 0.2 mm. Thereafter, the synthetic resin pipe is inserted into the metal pipe, and the metal pipe with the inserted synthetic resin pipe is left as they are at a room temperature. Then, the synthetic resin pipe rapidly expands to be in close contact with the metal pipe. Further to this contact, the metal pipe is heated to a certain temperature (not higher than 80° C.), so that the metal pipe is adhered to the synthetic resin pipe.

The above-mentioned method has an advantage in that the metal pipe and the synthetic resin pipe are not separated from each other because the metal pipe stands against a diametrical expansion force of the synthetic resin pipe. However, when the metal pipe layer and the synthetic resin pipe layer do not have a proper adhesive force therebetween, the two pipe layers may differently expand in a longitudinal direction at the room temperature, and may, moreover, expand even beyond a tolerance of expansion, which causes the pipe product having double layers to be defective.

### DISCLOSURE OF INVENTION

Accordingly, the present invention has been made to solve the above-mentioned problems occurring in the prior art, and an object of the present invention is to provide a method for manufacturing a pipe having double layers, which enables the adhesion between a metal pipe layer and a synthetic resin pipe layer of the pipe to be stably maintained even when external environment changes.

To accomplish this object, there is provided a method for manufacturing a pipe in accordance with the present invention, the methods comprising: a first step of forming a synthetic resin pipe having a double layer-structure, a second step of, following the first step, inserting the synthetic resin pipe into a metal pipe, a third step of, following the second step, heating the metal pipe to render an adhesive resin of the synthetic resin pipe heated up to a softening temperature thereof, and a fourth step of, following the third step, exhausting air between an inner surface of the metal pipe and an outer surface of the synthetic resin pipe, so as to make a space between the inner surface of the metal pipe and the outer surface of the synthetic resin pipe be vacuum, so that the metal pipe and the synthetic resin pipe are bonded together.

### BRIEF DESCRIPTION OF DRAWINGS

The above and other objects, features and advantages of the present invention will be more apparent from the following detailed description taken in conjunction with the accompanying drawings, in which:

FIG. 1 is a partly cutout perspective view of a pipe having double layers, which is manufactured by a method in accordance with a preferred embodiment of the present invention;

FIG. 2 is a transverse sectional view of a pipe having double layers in accordance with the preferred embodiment of the present invention;

FIG. 3 is a partly cutout illustrative side view of one side of an air suction device employed in the preferred embodiment of the present invention;

FIG. 4 is a partly cutout illustrative side view of the other side of an air suction device employed in the preferred embodiment of the present invention;

FIG. 5 is a partly cutout illustrative side view of one side of a high-frequency induction heating device employed in the preferred embodiment of the present invention; and

FIG. 6 is a flow chart of a method for manufacturing a pipe having double layers in accordance with the preferred embodiment of the present invention.

### BEST MODE FOR CARRYING OUT THE INVENTION

Hereinafter, a preferred embodiment of the present invention will be described with reference to the accompanying drawings. In the following description and drawings, the same reference numerals are used to designate the same or similar components, and so repetition of the description on the same or similar components will be omitted.

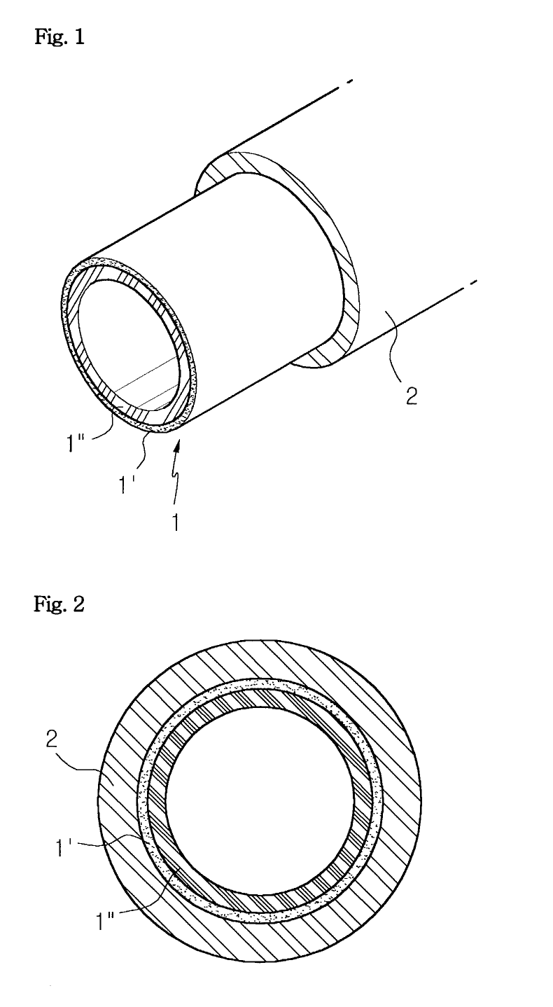

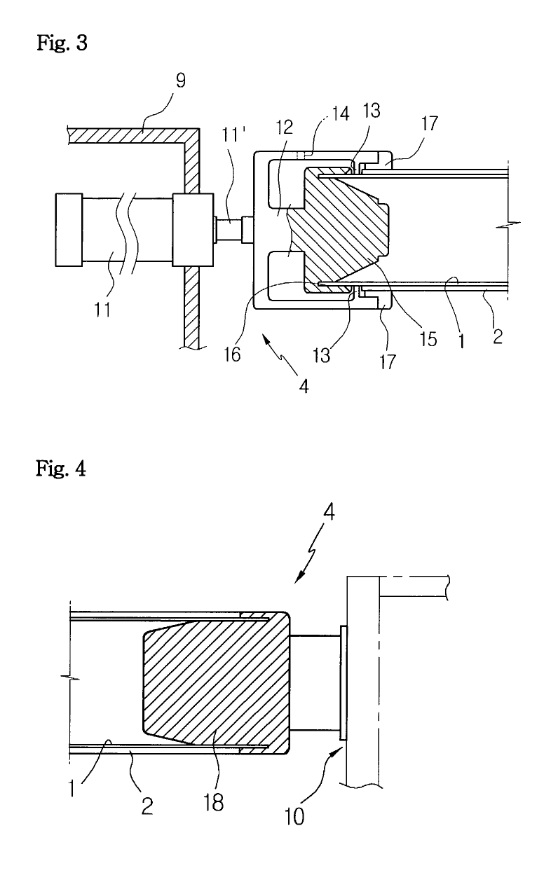

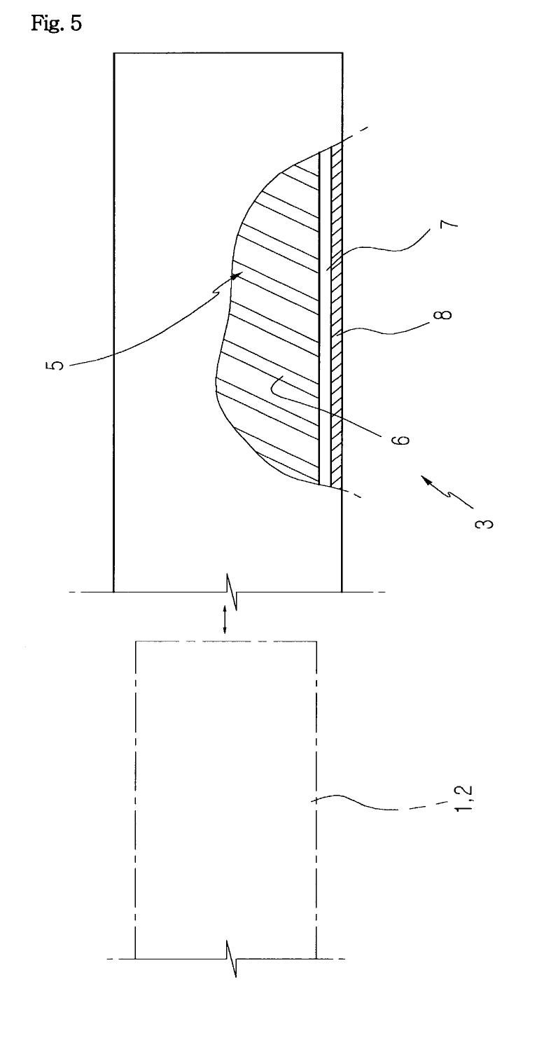

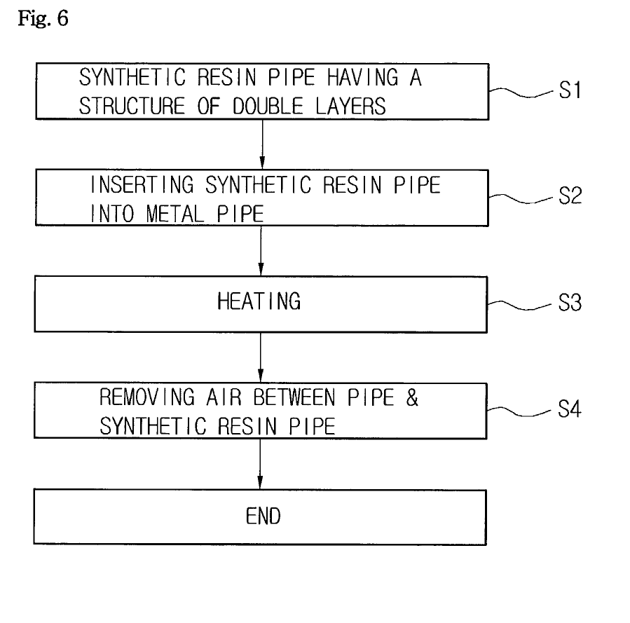

As shown in FIGS. 1 to 6, a method for manufacturing a pipe having double layers according to the present invention comprises four steps S1 to S4. In the first step S1, a synthetic resin pipe 1 is so formed as to have a double structure of an adhesive resin 1′ and polyethylene 1″. In the second step S2 following the first step S1, the synthetic resin pipe 1 is picked up and inserted into a metal pipe 2. In the third step S3 next to the second step S3, the metal pipe 2 is heated by high-frequency induction heating means 3, so that the adhesive resin 1′ of the synthetic resin pipe 1 is heated up to its softening temperature. Following the third step S3, finally conducted is a fourth step S4, in which air between an inner surface of the metal pipe 2 and an outer surface of the synthetic resin pipe 1 is sucked out by an air suction machine 4, so as to make the space between an inner surface of the metal pipe 2 and an outer surface of the synthetic resin pipe 1 vacuum. In result, the metal pipe 2 and the synthetic resin pipe 1 are tightly and steadily bonded together.

The synthetic resin pipe 1 is formed by the adhesive resin 1′ and the polyethylene 1″ in such a manner that the outer surface of the synthetic resin pipe 1 (consisting of the polyethylene 1″) is coated with the adhesive resin 1′ such as polyolefin (C₄H₄O₄) so as to be molten and bonded to the inner surface of the metal pipe 1 during heating of the metal pipe 2. The adhesive resin coating 1′ has a thickness of 0.4 to 0.6 mm, and the synthetic resin pipe 1 is so dimensioned that its outer diameter is smaller by 0.6 to 0.8 mm than an inner diameter of the metal pipe 2 and its length is longer by 40 to 50 mm than that of the metal pipe 2. The polyethylene 1″ may be replaced by polypropylene and so forth.

The high-frequency induction heating means 3 for heating the metal pipe 2 may be also replaced with a low-frequency induction heating means, a gas heating furnace, an electric heating furnace, etc., and the high-frequency induction heating means 3 itself comprises a main body part 5 on which a coil 6 is wound, a cooling water-flow channel part 7 located outside of the main body part 5, and a protective band 8 covering an outer side of the cooling water-flow channel part 7.

The main body part 5 conducts heat generated by a high-frequency wave passing through the coil 6 to the metal pipe 2 introduced into the main body part 5, thus rendering the adhesive resin 1′ heated up to its softening temperature (140 to 165° C.), and the cooling water-flow channel part 7 and the protective band 8 function to prevent heat of the main body part 5 from being emitted toward the exterior and to externally protect the main body part 5. The main body part 5 of the high-frequency induction heating means 3 is operated through a control box (not shown).

The air suction machine 4 comprises a body 9 and a fixing block 10. The body 9 is provided with a hydraulic cylinder 11, the hydraulic cylinder 11 has a rod 11′ whose tip end is formed with a supporting and suction part 12, and the supporting and suction part 12 is formed with a vacuum gate 13, a vacuum outlet 14 and a head 15. The vacuum gate 13 and the vacuum outlet 14 are communicated with a vacuum pump and an air suction part (not shown) to exhaust the air between the metal pipe 2 and the synthetic resin pipe 1. The head 15 supports a projecting portion 16 of the synthetic resin pipe 1, and a fixing fitting 17 is disposed beside the vacuum gate 13 so as to enable the synthetic resin pipe 1 and the metal pipe 2 supported by the head 15 to be retained stably.

The other side of the metal pipe 2, an opposite side to the side on which the supporting and suction part 12 is disposed, is joined with a head 18 fixed to the fixing block 10. As the rod 11′ of the hydraulic cylinder 11 goes forward and backward, the fixing block 10 and the head 18 are moved while supporting the synthetic resin pipe 1 and the metal pipe 2. Just when the fixing block 10 and the head 18 is moved so, the high-frequency induction heating means 3 is actuated to conduct heat to the metal pipe 2, and the air between the synthetic resin pipe 1 and the metal pipe 2 is exhausted so that two pipes 1, 2 are tightly bonded together.

A cutter (not show) is provided for removing the projecting portion 16 of the synthetic resin pipe 1 after the synthetic resin pipe 1 and the metal pipe bonded together are subjected to a rapid cooling treatment.

The present invention having the above-mentioned construction realizes steady closeness of the bonded portion between the synthetic resin pipe 1 and the metal pipe 2 even if external environment changes.

Now, a detailed description will be given for processes of the inventive method.

First, the synthetic resin pipe 1 is so formed that the adhesive resin 1′ is coated on its outer side and the polyethylene 1″is positioned on an inner side of the adhesive resin 1′, and then is inserted into the metal pipe 2.

The metal pipe 2 with the inserted synthetic resin pipe 1 (hereinafter, referred to as pipe 1, 2) is picked up and is in position using a picking-up device in such a manner that one side of the pipe 1, 2 is positioned at the head 18 of the fixing block 10 and the other side is positioned at the head 15 of the supporting and suction part 12. The pipe 1, 2 supported by the fixing block 10 and the supporting and suction part 12 is moved through an inner side of the high-frequency induction heating means 3. At this time, such a movement of the pipe 1,2 is done by operation of the hydraulic cylinder 11.

When the pipe 1, 2 is moved through the high-frequency induction heating means 3 at an appropriate speed, the coil 6 wound on the main body part 5 of the high-frequency induction heating means 3 is excited to conduct heat to an outer periphery of the metal pipe 2. When the adhesive resin 1′, an outer layer of the synthetic resin pipe 1, is softened by such a heat conducted to the metal pipe 2, air present between the synthetic resin pipe 1 and the metal pipe 2 is exhausted through the vacuum gate 13 and the vacuum outlet 14 to make the synthetic resin pipe 1 and the metal pipe 2 tightly bonded together, and then the pipe 1, 2 having completed the tight-bonding is subjected to a cooling treatment, so that the synthetic resin pipe 1 ceases its deformation as it is in a molten bonded state. Since air between the synthetic resin pipe 1 and the metal pipe 2 is completely removed through the vacuum gate 13 and the vacuum outlet 14, a stronger bonding force can be obtained and perfect bonding can be realized even if the inner surface of the metal pipe 2 is formed with minute prominences and depressions.

When the deformation of the synthetic resin pipe 1 is ceased, the synthetic resin pipe 1 and the metal pipe 2 come to form a sing pipe 1, 2, that is, the synthetic resin pipe 1 is integrated with the metal pipe as it is in the molten bonded state, so that it does not contracted or expanded beyond a tolerance limit. Since the molten bonding of the synthetic resin pipe 1 is due to thermal molten bonding of the adhesive resin 1′ as a solid adhesive agent which has an tendency to be molted and bonded in compliance with undulations of the metal pipe, a perfect product without pores can be obtained.

After the synthetic resin pipe 1 and the metal pipe 2 are integrated with each other, the projecting portions 16 of the synthetic resin pipe 1 located on both sides of the metal pipe 2 is cut by the cutter to thereby obtain a finished product.

### Industrial Applicability

As stated above, the present invention can realize perfect bonding between a synthetic resin pipe and a metal pipe by forming the synthetic resin pipe as a composite of an adhesive resin and polyethylene, inserting the synthetic resin pipe into the metal pipe, and externally heating the metal pipe to make the adhesive resin of the synthetic resin pipe thermally molten and bonded to an inner surface of the metal pipe while removing air between the synthetic resin pipe and the metal pipe.

The synthetic resin pipe and the metal pipe is integrated with each other due to the thermal molten bonding of the adhesive resin, which reduces production costs and simplifies manufacturing processes. Also, since the bonded portion by the molten bonding is always maintained in a fixed state, adaptability for change of external environment is improved.

In addition, the conventional manufacturing method using a liquid adhesive agent has a drawback of manufacturing difficulty because prominences and depressions on the inner surface of the metal pipe must be removed, but the present invention provides easy and simple manufacturing due to the fact that the adhesive resin is molten and bonded to the inner surface of the metal pipe without regard to existence of the prominences and depressions.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing a pipe having double layers, the method comprising the steps of:
(S1) forming a synthetic resin pipe having a double layer-structure;
(S2) inserting the synthetic resin pipe into a metal pipe;
(S3) heating the metal pipe to make an adhesive resin of the synthetic resin pipe be heated up to a softening temperature of the synthetic resin pipe; and
(S4) exhausting air between an inner surface of the metal pipe and an outer surface of the synthetic resin pipe, so as to make a space between the inner surface of the metal pipe and the outer surface of the synthetic resin pipe be vacuum, so that the metal pipe and the synthetic resin pipe are bonded together.

2. The method according to claim 1, wherein the synthetic resin pipe comprises adhesive resin and polyethylene.

3. The method according to claim 2, wherein the outer layer of the synthetic resin pipe is formed from the adhesive resin of polyolefin.

4. The method according to claim 1, wherein the metal pipe is heated by high-frequency induction heating means.

5. The method according to claim 4, wherein the high-frequency induction heating utilizes a high-frequency wave, a low-frequency wave, a gas or the like as a heating source.
